(19) United States
(12) Patent Application Publication
(10) Pub. No.: US 2007/0251074 A1
(43) Pub. Date: Nov. 1, 2007

(54) Method and apparatus to promote used oil filter recycling and biological control of their residual oil

(76) Inventors: Adan Reinosa, Montebello, CA (US); Robert J. Hammer, Rancho Palos Verdes, CA (US)

Correspondence Address: Adan Reinosa, 1729 Westmoreland Drive, Montebello, CA, 90640, US

(21) Appl. No.: 11/648,409

(22) Filed: Dec. 28, 2006

Related U.S. Application Data
(60) Provisional application No. 60/754,526, filed on Dec. 28, 2005.

(51) Int. Cl. B23P 6/00

(52) U.S. Cl. 29/402.04

(57) ABSTRACT

The present invention attaches to the bottom of the used filter in a one-way locked fashion. It can be described as a concave surface, equipped with a plurality of one-way locking barbs, or locking means, that upon a quick insertion, or turning process into the normally provided center threaded channel of a spin-on oil filter, makes positive seal against the normally provided gasket in oil filters, transforming the filter into a sealed container or cylinder. The present invention is also equipped with a time-release oil-eating bacteria, or other suitable biological agent, to eventually render the filter residual oil inert to the environment if the filter is still illegally dumped. Therefore, the device prevents the oil filter from leaking shortly after it is removed and substantially hot drained, to facilitate transportation to a suitable recycling or collection center, thereby enabling the recovery and recycling of used oil filters.

### CROSS-REFERENCE TO RELATED APPLICATIONS

This application is entitled to the benefit of Provisional Patent Application Ser. No. 60/754,526 filed 2006 Dec. 26.

### BACKGROUND OF THE INVENTION

The present invention relates to a device for the prevention of contamination by the illegal disposal of spin-on oil filters and the biological control of residual oil inside them. Although devices have been patented in the past for the same prevention, the present invention teaches a way that is so simple to use and inexpensive that it holds promise for its widespread adoption.

### DESCRIPTION OF THE PRIOR ART

### Background

Used motor oil that has been used for the lubrication of engines, generally referred to as used motor oil, is a significant threat to the environment. Used motor oil is a pollutant that contains toxic chemicals, heavy metals, and other contaminants. The United States Environmental Protection Agency (EPA) estimates that the amount of used oil from a single oil change, approximately a gallon, of an automobile engine can ruin up to a million gallons of fresh water, and the EPA classifies used motor oil as hazardous waste. This oil is even more contaminated when it comes from the used oil filter, since the filter traps high concentrations of metal particles such as iron, lead, manganese, boron, and zinc, among others.

Our experience shows that the main reason for the utter failure of the current programs for the recovery and recycling of spin-on oil filters is simply that used filters, once removed from the engine, are too messy to handle. Oil changers or Do It Yourselfers (DIYs), and Shade-Tree Mechanics (STMs), do not generally recycle their filters because it is so much more convenient to dump them in the trashcan. This is due to poor environmental education and lack or difficulty of enforcement at the local, state, and federal levels. Incentives, financial or otherwise, to recycle used filters are not available. Consequently, the majority of used oil filters, up to 95% in some cases, find their way to our landfills, via the trashcan. This is a clear and present threat to our environment, and more specifically our waterways, due to the eventual deterioration of the filter metal enclosure and the resulting oil leakage and migration into the water table. So, the dismal failures of education, coupled to whatever tool there might be, are at present an utter failure. Whatever US Patents issued for such devices, and/or recycling programs, are therefore largely ineffective, as demonstrated by current oil filter recycling metrics. The prior art has utilized various techniques to address this problem. U.S. Pat. No. 5,431,588 to Kucik disclosed an oil filter cartridge having a nipple on the bottom of the filter and a valve for opening the nipple to drain residual used oil remaining in the oil filter cartridge after used oil has been drained from a crankcase. The Kucik device requires the use of a used oil container disposed directly under the outlet of the nipple for the receipt of used oil, or the use of a hose connected to the end of the nipple as well as a container disposed directly under the end of the hose opposite the nipple for the receipt of used oil. As disclosed in the Kucik patent, other prior art techniques include disposing a large plastic bag directly under the filter cartridge assembly for the receipt of used oil released from the filter cartridge during unscrewing and removal of the filter cartridge assembly. These patents show complicated and expensive processes for DIYs, and therefore difficult to implement in a large scale.

The conventional techniques used to minimize the spillage of used oil during the unscrewing and removal of an oil filter from an engine has several limitations. These techniques involve the transfer of used oil released from an oil filter cartridge. Associated with each of these used oil transfer steps, including the transfer of used oil into and out of hoses and into various containers including plastic bags, is the risk of used oil spillage.

These methods also result in the contamination of various articles associated with transferring and containing used oil released from an oil filter cartridge. To address the limitations of the prior art, what is needed is an improved method to solve the continued leakage of oil at the earliest possible time, and at the source, shortly after the moment of removal. Further, what is needed is a method and a device for sealing a used oil filter cartridge from an engine that is simple and easy to use, and that minimizes or eliminates the release of used oil from the cartridge, and thereby reduces the adverse impacts to the environment resulting from the mismanagement of used oil filters.

Patents such as U.S. Pat. No. 5,431,588, to Kucik; U.S. Pat. No. 4,977,978 to Batrice; U.S. Pat. No. 5,074,379 to Batrice; U.S. Pat. No. 4,909,205 to Bewley; U.S. Pat. No. 4,909,205 to Meisenburg; U.S. Pat. No. 4,101,000 to Scully; U.S. Pat. No. 5,196,112 to Eichman; U.S. Pat. No. 4,986,777 to Preston; U.S. Pat. No. 4,815,566 to Caruso; U.S. Pat. No 6,485,637 to Jainek et al.; U.S. Pat. No. 5,366,400 to Kucik; U.S. Pat. No. 4,930,602 to Gust; U.S. Pat. No. 6,101,996 to Arita et al.; and even Tokkai Hei 9-173716 published by the Japanese Patent Office in 1997, either deal with the oil filter spillage problem in a complicated and costly manner, or ignore altogether the consequences of simply removing the filter.

Further, the applicants performed an Internet search with the terms “used oil filter” and “pollution” in the United States Patent Database to assist the examiner and to research relevant prior art, and the following relevant results were found: U.S. Pat. No. 6,742,551 for a Method and apparatus for efficient distribution and recovery of recyclable/reclaimable materials; U.S. Pat. No. 6,287,464 for an Oil filter assembly; U.S. Pat. No. 5,890,424 for a Method and apparatus for recycling a used fluid filter; U.S. Pat. No. 5,839,350 for a Means and method for preparing a container for recycling; U.S. Pat. No. 5,564,525 for a Method and apparatus for transporting new and spent liquids; U.S. Pat. No. 5,542,442 for a Used oil filter cleaning system; U.S. Pat. No. 5,489,042 for a Reusable waste handler for vehicular oil changes; U.S. Pat. No. 5,421,381 for a Reusable used oil filter and oil recycling container; U.S. Pat. No. 5,298,079 for a Process for cleaning used oil filters; U.S. Pat. No. 5,060,564 for Means to extract oil from used automotive oil filter; U.S. Pat. No. 5,044,334 for a Process for clean simple and high speed oil change and/or flushing of the moving components of the crankcase in an internal combustion engine; U.S. Pat. No. 4,815,591 for an Oil change container; U.S. Pat. No. 4,533,042 for a Motor oil change kit and catch pan for use in changing automotive motor oil, and U.S. Pat. No. 4,403,692 for a Motor oil change kit. It is of interest to note that the search terms are very relevant to the present invention, and yet no similar device was found.

The applicants further searched yet another relevant query, this time to search for “used oil filter” and the term “plug”, and the following non-relevant US Patents results were found: U.S. Pat. No. 6,652,664 Oil pump screen cleaning method and apparatus; U.S. Pat. No. 6,651,777 Apparatus for enhancing engine oil changes; U.S. Pat. No. 6,540,914 Cleanable filter with spinning screen; U.S. Pat. No. 6,488,848 Cleanable filter with ported cylinder adjacent screen; U.S. Pat. No. 6,457,493 Method and apparatus for efficient distribution and recovery of recyclable/reclaimable materials; U.S. Pat. No. 6,318,417 Method and apparatus for efficient distribution and recovery of recyclable/reclaimable materials; U.S. Pat. No. 6,234,220 Method and apparatus for efficient distribution and recovery of recyclable/reclaimable materials; U.S. Pat. No. 6,145,622 Fluid change system; U.S. Pat. No. 6,135,501 Lubricant delivery and retrieval vehicle and methods of manufacture and operation thereof; U.S. Pat. No. 6,068,032 Container and system for collection and recycling used motor oil; U.S. Pat. No. 5,890,424 Method and apparatus for recycling a used fluid filter; 5,839,350 Means and method for preparing a container for recycling; U.S. Pat. No. 5,830,371 Reusable fluid filter and adapter; U.S. Pat. No. 5,782,315 Oil filter pump and automatic method for prelubricating an engine; U.S. Pat. No. 5,775,385 Process and system for changing oil; U.S. Pat. No. 5,647,414 Curbside oil and oil filter recycle and collection apparatus and method; U.S. Pat. No. 5,569,373 Reusable fluid filter and adapter; U.S. Pat. No. 5,564,525 Method and apparatus for transporting new and spent liquids; U.S. Pat. No. 5,421,381 Reusable used oil filter and oil recycling container; U.S. Pat. No. 5,372,219 Method and apparatus for performing fluid changes in an internal combustion engine; U.S. Pat. No. 5,365,808 Oil filter shut off valve wrench and method; U.S. Pat. No. 5,246,086 Oil change system and method; U.S. Pat. No. 5,243,754 Apparatus for severing of an oil filter, separating the components of the filter and crushing of the same to facilitate recycling or waste disposal thereof; U.S. Pat. No. 5,209,198 Process for simple and high speed oil change and/or flushing the engine oil distribution channels of the moving components of the crankcase in an internal combustion engine; U.S. Pat. No. 5,168,844 Adapter system for use with an internal combustion engine flushing apparatus; U.S. Pat. No. 5,070,831 Oil change system and method; U.S. Pat. No. 5,044,334 Process for clean simple and high speed oil change and/or flushing of the moving components of the crankcase in an internal combustion engine; U.S. Pat. No. 5,023,133 Acid sensor; U.S. Pat. No. 4,964,373 Withdrawn; 30 U.S. Pat. No. 4,951,784 Process and device for simple, high speed oil change and/or flushing and air purging of the moving components of the crankcase in an internal combustion engine; U.S. Pat. No. 4,930,602 Oil drain system; U.S. Pat. No. 4,909,205 Method and apparatus for changing engine oil; U.S. Pat. No. 4,815,591 Oil change container; U.S. Pat. No. 4,791,374 Acid sensor; U.S. Pat. No. 4,756,411 Marketing system for apparatus for changing engine oil; U.S. Pat. No. 4,533,042 Motor oil change kit and catch pan for use in changing automotive motor oil; U.S. Pat. No. 4,450,075 Magnetic oil filter insert, and U.S. Pat. No. 4,403,692 for a Motor oil change kit.

The most relevant U.S. Patent found for the present invention is an Oil filter unit and sealing device to Carlisle, U.S. Pat. No. 4,507,199, which references an equally relevant U.S. Pat. No. 4,451,368 issued to Pandelana on March 1984. The following further reference devices used to contain, or limit the spillage from filters during an oil change were found: U.S. Pat. No. 6,227,078, Engine oil filter socket wrench with built-in spillage cup; U.S. Pat. No. 5,741,420, Dew forming prevention apparatus; U.S. Pat. No. 5,469,935, Oil filter removal aid; U.S. Pat. No. 5,366,084, Containers positionable over oil filters of motors for precluding the spillage of oil; U.S. Pat. No. 5,169,541, Hazardous materials spillage inhibitor for use with service station fuel filters; U.S. Pat. No. 4,948,503, Oil filter cover in combination with an oil filter cartridge; U.S. Pat. No. 4,929,356, Environment protector for replaceable cartridge filters; U.S. Pat. No. 4,913,813, Filter spill prevention cover; U.S. Pat. No. 4,882,051, Cartridge filter incorporating a bag-like body; U.S. Pat. No. 4,877,155 Spill protecting apparatus; U.S. Pat. No. 4,865,731, Pre-filled fuel filter for internal combustion engines; U.S. Pat. No. 4,865,727, New and used oil filter container with used filter removing means; U.S. Pat. No. 4,642,183, Oil filter; U.S. Pat. No. 4,604,202, Filter apparatus, and U.S. Pat. No. 4,507,199 for an Oil filter unit and sealing device.

The U.S. Pat. No. 4,507,199, issued to Carlisle for an Oil Filter Unit and Sealing Device is the most relevant found by the applicants. This patent discloses a cover, which substantially accomplishes the sealing of a used oil filter. However, the present invention overcomes clear disadvantages of the Carlisle device. The Carlisle device is designed for avoiding oil leakage from a used filter for the purposes of avoiding fire hazard, delivering a sealed used oil filter for wear analysis, prevent contamination on new filters, and pollution prevention is not even contemplated. The Carlisle device lacks permanency since it is easy to remove it from the used filter by simply unscrewing it, either by accident or by willful action. Finally, the Carlisle device is preferred not to deform while screwing it on, therefore foregoing the utility of the present invention which by its domed shape takes advantage of its deformation to accommodate variations in filter configurations and its consequent storage of potential energy to sealingly spring against the normally provided oil filter gasket.

The Carlisle patent, clearly the closest reference found by the applicants, is referred by 12 patents, of which the following are the most relevant to the present invention: U.S. Pat. No. 4,376,703, to Krauss, claiming a reservoir to contain spilled oil while removing the filter from the engine, where the application is different and a costlier and more complicated device; U.S. Pat. No. 5,702,599, to Brown, recognizing that a cover will help the environment; U.S. Pat. No. 5,271,836 and U.S. Pat. No. 6,364,121 to Janik, et al., teach a disposal plug and filter cartridge with grommet spring respectively, and although recognizing briefly its potential positive role for the environment on the second cited patent, it is clearly targeted for fuel filters and its complexity clearly results in a much more costly device than the present invention. Two design patents D459,284 and D453,011 claim just the form of the device: “I claim the ornamental design for a oil or fuel filter cap, as shown and described”, and not a method or function for environmental mitigation, biological agent control, nor pollution prevention. In fact, in addition to the previous cited patents dealing with either the recovery and/or treatment of used oil and filters, the following steps are present recommendations, as of Feb. 17, 2004, and again with no change on Dec. 26, 2005, from the Filter Manufacturing Council (FMC) website, as steps to encourage the recycling of used oil filters:

“Step 1. Remove the filter from the engine to “hot-drain” it while the engine is still warm. Hot draining is defined as draining the oil filter at or near engine operating temperature but above 60 degrees Fahrenheit.

WARNING: Use extreme caution when hot-draining filters to avoid burns. Wear protective equipment such as safety glasses and gloves.

Step 2. Using a tool such as a screwdriver, carefully puncture the dome end of the filter. Then, turn the filter upside down so it can drain completely into your container for used oil recycling. Allow the filter to drain overnight (or a minimum of 12 hours) to remove all the oil.

Step 3. Recycle used oil and drained oil filters at your local garage or special waste-recycling center. Check with your local service station or contact your city or county recycling official for information about collection centers. Some auto parts stores also accept used oil and drained filters for recycling.”

Further, performing a web search on one of the most powerful databases in the Internet, Google, yields no reference to a device like the present invention. However the following hits will illustrate the current “state-of-the-art” recommendations:
USEPA requirements for hot draining a used oil filter can be accomplished by any of the following methods. • Puncture the filter dome or anti-drainback valve and hot drain. From link:
   http://cpgparts.alliedsignal.com/cpg/catalog/fram/legal/Environmental.pdf.
How should I handle used filters?. Puncture the domed part of an oil filter with a sharp tool, being careful not to injure yourself. Drain filters on a rack while they are warm for several hours, capturing the oil for recycling as described above. From: Regional Waste Systems, a non-profit solid waste management corporation that serves 27 cities and towns in Cumberland, Oxford, and York counties in Maine.
Drain the filter of any oil. Using a sharp tool, puncture a hole in the dome end of the filter or through the antidrain back valve located on the flat end of it. The most effective method for properly draining the filter is to puncture the antidrain back valve or the filter dome and allow the used oil to flow into a container appropriate for recycling it. From: United States Environmental Protection Agency, EPA 530-F-94-008, March 1994, Solid Waste and Emergency Response (5305).
Place the flat end of the punctured filter on the used oil collection container and drain as much used oil as possible out of the filter. It is important for used oil filters to be drained a minimum of 12 hours near engine operating temperature. From link:
   http://www.epa.gov/grtlakes/seahome/housewaste/src/recycle.htm

Similar recommendations are found at the following links:
http://es.epa.gov/techinfo/facts/oilreuse.html
http://www.deq.state.la.us/assistance/recycling/home/motoroil.htm;
www.cayuganet.org/hazwaste/oil.pdf
www.filtercouncil.org/envinfo/educational/rechome.html
www.state.in.us/idem/ctap/vehicle/manual/ch4oilfilters.pdf
www.state.in.us/idem/ctap/vehicle/manual/ch4oilfilters.pdf
www.peakantifreeze.com/article_{—a.html}
www.pca.state.mn.us/publications/ea-sl-24.pdf
www.metrokc.gov/hazwaste/house/oilandgas.html
www.state.ma.us/dep/recycle/hazards/motoroil.htm
www.gov.ns.ca/tran/whoweare/WEM/waste%20materials%20guide.pdf
http://www.hazardouswaste.utah.gov/ADOBE/usedoil/sprin01drip.pdf
http://www.montgomerycountymd.gov/mc/services/dep/Factsheets/filter.htm;
http://www.health.state.nd.us/ndhd/environ/wm/pdf/mo_filters.pdf

Our field experience has shown us that most DIYs will not puncture filters, nor wait a minimum of 12 hours to get dirty once again. They will rarely wear thermal gloves or safety glasses, and most DIYs, just as statistics show, will simply take the easy way out: dump the filter in the trashcan and avoid the hot and messy leaking used oil filter.

Therefore, this approach has been “Dead On Arrival”, resulting in the continuing dumping of used oil filters. In addition, we have learned that even well meaning people are too impatient to permit all of the used oil to drain from the filter before discarding it.

In fact, the inspiration for the present invention is a direct result of interviews on behalf of a used motor oil and used filters recovery program that we have spearheaded called RECOIL. The program is currently running in a California city, Baldwin Park. One of the past recovery metrics in Baldwin Park was that in a calendar quarter, 80 gallons of used motor oil were recovered, but along with only 4 used oil filters. This indeed lends credence to the often-cited 95% rate of used oil filter dumping. Therefore, the FMC and EPA recommendations for the recycling of used oil filters have been obviously largely ineffective and ignored by DIYs in view of the up to 95% used oil filter dumping problem, in spite of their claims of voluntary DIY recycling.

In fact, from an October, 2005, 200 page report to The Honorable California Governor Arnold Schwarzenegger, the following we consider very good and relevant background, an we quote:

“To the Greatest Extent Possible”: Do-It-Yourselfers and the Recovery of Used Oil and

Filters Produced under contract by Public Research Institute October 2005 CIWMB

Publication #611-05-008

From Section 11

Filter Disposal Methods—Underestimation of Improper Disposal

The survey estimate of proper disposal (59 percent) is not consistent with the CIWMB block grantee reports of oil filter collection for 2003-04, which show the following: Only 968,585 filters, or 3.9 percent of 24.9 million estimated DIY filters, were collected from DIYers by filter collection programs statewide.*

Who Disposes of Filters Improperly?

More than 95 percent of filters were disposed improperly in 2003-04, according to the Board's data from block grantees. Therefore, little variation is present in the statistics.

None of the standard demographics are associated with improper disposal of filters: not gender, age, income, immigrant or U.S.-born, STM activity, or rural-urban. What explains improper disposal is not variation among DIYers, but the lack of an infrastructure for oil filter recycling statewide. We can examine rates of collection-that is, proper disposal-in counties by combining survey and block grantee report data.

1. Controlled studies show that the residual oil remaining in automotive oil filters disposed by DIYers is considerably greater than previously thought. The estimated range is 10-11 oz. per filter on average, compared to ranges of 3.5-8 oz. and 2-8 oz. commonly cited.

2. We estimate that 2.18 million gallons of oil remained in filters that California DIYers disposed of (properly and improperly) in 2003-04.

3. Improperly disposed DIY filters contained an estimated 2.09 million gallons in 2003-04, about twice what we might have estimated if we used the midpoints of the commonly cited ranges of residual oil.

4. We estimated the approximate number of filters disposed by STMs and other DIYers in each county and the percent of the filters disposed that were collected by block grantees in 2003-04. Combining data from the statewide survey and block grantee reports to the Board, we estimate that statewide, only 3.9 percent of DIY filters were collected.

Most counties collected less than 5 percent of DIY filters. Only six counties collected more than 20 percent.

5. The probability of improper filter disposal by individual DIYers is related to county collection rate, as it should be. Media outreach shows some effect on filter disposal. Not much else explains improper disposal of filters: improper disposal is pervasive across demographic groups, reflecting the lack of filter-collection infrastructure statewide. No single group disposes improperly at a significantly higher rate than any other.

6. The amount of oil remaining in improperly disposed filters has been seriously underestimated. Many DIYers are not aware that disposal of filters is a problem. The collection rate for filters is very low statewide and in most localities. Increasing the collection of filters for recycling is a more effective way of recovering used oil than previously thought.

7. The CIWMB helps to operate Earth 911 (1-877-EARTH911) and 1-800-CLEANUP phone lines. These public referral systems provide information about used oil recycling, but assistance with oil filter recycling is difficult to obtain. Filters should be much more prominent on these systems, and vigorous efforts should be made to promote filter recycling and provision of curbside pickup for filters.

8. For the same reason that curbside collection is so effective at reducing improper disposal of liquid oil to zero, so curbside collection should also collect used oil filters and new oil containers so that the oil remaining in them can also be recycled “to the greatest extent possible.”

9. The Board should assess and revise the system for reporting filter collection. In particular, it should re-evaluate the rules for translating a known weight of collected filters into the number of filters collected. From the survey data we estimate that DIYers in California used 24.9 million oil filters in 2003-04”.

In fact, from an article dated Apr. 25, 2005, by the California Integrated Waste Management Board celebrating the “success” of 182% increase in used oil filter recovery, we quote: “City of L.A. Reaps Rewards from Oil Filter Recycling Partnership with Kragen: Collection Increases 182 Percent

Do-it-yourself oil changers (DIY) in California currently purchase more than 20 million oil filters annually. Unfortunately, less than 10 percent of used oil filters are recycled.

This means that an estimated 1.2 million gallons of oil in discarded oil filters go to landfills each year.

To reverse this wasteful trend, the City of Los Angeles is partnering with the CSK Corporation to conduct oil filter collection/exchange events at Kragen auto parts stores within the city limits.

The result: Within one year, collection of used oil filters in the city rose from 4,250 to more than 12,000, resulting in the recycling of 18,300 pounds of steel and 11,700 pounds of oil. This represents an increase of 182 percent! During this same time period, oil recycling increased 60 percent.”

According to the Los Angeles Almanac there are 5.2 million vehicles registered in Los Angeles. The claim of “Within one year, collection of used oil filters in the city rose from 4,250 to more than 12,000”, rings rather insignificant, even when assuming two filter changes per year, or 10.4 million filters sold.

The obvious low recovery and recycling of this otherwise valuable resource militates in favor of the fact that there is still a need for a device that is easier to use, safer to use, cleaner to use, faster to install and environmentally sound. In short, logic follows that if all those patents, education, programs, and recommendations from the leading filter and other environmentally focused organizations, in combination or alone, have not stopped the used oil filter-dumping problem, then and therefore a new simpler approach is still needed to dramatically increase the recycling of used filters through the use of a simple tool in order to mitigate this irresponsible behavior.

### SUMMARY OF THE INVENTION

Illegal used motor oil and used oil filter dumping in the United States has been recognized by the EPA as the number one threat to pollution in the United States waterways. Every year, illegal dumping of used motor oil by Do It Yourselfers results in the equivalent of the Exxon Valdez spill every ten days, approximately 11 million gallons. As a result of that, millions of gallons of re-refinable oil are lost forever to the environment. This not only depletes already scarce natural resources, but also promotes untold damage to our environment.

Along with used motor oil dumping, a more egregious statistic belongs to the used oil filter, also known as the spin-on oil filter. Currently, used oil filters are recycled to the rate between 5-10%, with the balance being dumped generally in the trashcan, streets, curbs, and waterways. To put this in perspective, every ton of dumped oil filters yields approximately 60 gallons of the worst polluted oil and 1700 lbs of steel. Yet even with this information, the rate of recovery over the last ten years has hardly improved. One often-cited statistic is that the rate of recovery of used motor oil has improved an insignificant 1%, in spite of grants, research and educational efforts at the local, state and federal levels.

Clearly, in the battle against used motor oil and oil filter dumping, education alone is not effective in curbing this damaging behavior. The public in general, wants to be active in cleaning the environment, but the process should:
a) Make the task at hand easier;
b) make the task faster;
c) make the task cleaner;
d) make the task safer;
e) make the task environmentally rewarding, and
f) provide safeguards if filters are still illegally dumped.

These elements have the power to curb illegal dumping by changing the very behavior that compels it. As such, the applicants have implemented the element of education, along with tools, through an environmental program called RECOIL. RECOIL matches education and tools that in combination promotes those listed elements, leading to the curbing of the illegal dumping behavior, and the mitigation of this environmental threat.

The RECOIL program addresses the dumping of used motor oil by providing for the easy removal of used motor oil by using a small portable pump. The small portable pump is connected at the time of an oil change to the oil sump of an engine, where the outlet of the pump is connected to a plastic bag with a one-way valve that is electromechanically interlocked to the outlet of the pump. The used oil filter is a challenge that the present invention directly answers. The messy state of the filter, once it is removed, has been identified as the number one reason why DIYs dump their filters in the trashcan. The device of the present invention, attaches to the bottom of the used filter in a one-way locked fashion. It can be described as a concave surface, equipped with a plurality of one-way locking means that upon insertion into the normally provided threaded channel of the filter, makes positive seal against the normally provided gasket, transforming the filter into a sealed container. The device in its preferred embodiment plugs the centrally located threaded hole with plugging and locking means to make its removal difficult once it is fitted to the used filter. In addition, since spin-on oil filters are generally designed with an anti-drain back membrane, the plugging of the center hole effectively traps the oil inside the used oil filter. Further, the device will stop any oil escaping through either the membrane or the center hole because a seal barrier has been effectively made between the normally provided oil filter gasket and the filter side surface of the device. So, the trapped oil has to go through three barriers in order to harm the environment, and as a last measure, the present invention is equipped with a time-release oil eating bacteria, or other suitable biological agent, which will eventually render the trapped oil harmless to the environment. Therefore, the device prevents the oil filter from leaking shortly after it is removed and substantially hot drained, to facilitate transportation to a suitable recycling or collection center. In addition, should the DIY or user after attaching the device of the present invention decides to harm the environment by dumping the used filter, the provided oil-eating bacteria, or biological agent, would render the residual oil inside the filter inert and harmless to the environment over a period of time. Further, the external surface of the device is also available for printing an environmental message as a last appeal to do the right thing for the environment and may include instructions, sponsoring information, nearest recycling center, among others.

### OBJECTS AND ADVANTAGES

Accordingly, there exists a need for a device to promote the recovery and recycling of spin-on oil filters, which by its simple design, ease of use, and fast application will promote the desired environmental protection results.

It is therefore, a primary object of the present invention to provide a spin-on oil filter recovery device to promote recycling, which includes unappreciated advantages and unsuggested modifications in prior art, that has all the advantages and the additional complementary benefits over prior art, and has none of the unrecognized problems and undesirable design shortcomings found in prior art.

An additional object of the present invention is to provide a spin-on oil filter recovery device to promote recycling, which is easy to use, and therefore promotes the adoption of its use.

Another object of the present invention is to provide a spin-on oil filter recovery device to promote recycling, which has the ability to provide a printable surface to communicate environmental messages, sponsoring messages, instructions for the recycling of used oil filters and oil on its external surface to further advance and ensure its environmental mission.

A further object of the present invention is to provide a spin-on oil filter recovery device to promote recycling, which is fast to use and therefore militates for its widespread adoption.

A still further object of the present invention is to provide a spin-on oil filter recovery device to promote recycling, which is cleaner to use and therefore promotes the handling of the used oil filter to avoid the messy situation of continuous leakage after removing the oil filter from the engine, which promotes the current rate of 95% dumping to crowded landfills.

Another object of the present invention is to provide a spin-on oil filter recovery device to promote recycling, which uses a cocktail mix of biological agents, such as oil-eating bacteria, fungi, or other biological agent to render the residual oil trapped in used oil filters harmless to the environment should the filter be abandoned or dumped.

A further object of the present invention is to provide a spin-on oil filter recovery device to promote recycling, which is safer to handle due to its ability to minimize the initial leakage and continued leakage of the internal oil in the used oil filter.

Yet another object of the present invention is to provide a spin-on oil filter recovery device to promote recycling, which makes the act of recycling the oil filter a rewarding experience

A further object of the present invention is to provide a spin-on oil filter recovery device to promote recycling, which is not complicated as other methods that propose plastic bags, drain cocks, special valves, and do not require extensive discipline for its use, and most important, a low cost of manufacture and sale to make it available on a widespread basis.

A still further object of the present invention is to provide a spin-on oil filter recovery device to promote recycling, which by its simplicity, ease of construction, practical use, extremely low price, ease of use, inherent use of the filter design parameters, inexpensive construction material, among others, will be available in large scale so that we can recover and avoid waste of national resources, and defer the use of natural resources.

Yet another object of the present invention is to provide a spin-on oil filter recovery device to promote recycling, which is made of recycled and recyclable materials to further advance even more its environmental mission.

Further objects of the invention will appear as the description proceeds and claims drawn. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

The present invention will be more fully understood by reference to the following detailed description thereof when read in conjunction with the attached drawings, in which like reference characters designate the same or similar parts throughout the several views, wherein:

FIG. 1 Is a detail side view illustrating the spin-on oil filter recovery device approaching the spin on oil filter.

FIG. 2 Is a top view of the filter side surface of the spin-on oil filter recovery device.

FIG. 3 Is a cross sectional view of the spin-on oil filter recovery device in its locked or deployed position where the device sealing surface is concave.

FIG. 3A Is a cross sectional view of the spin-on oil filter recovery device in its locked or deployed position where the device sealing surface is convex.

FIG. 4 Is a side view of four other embodiments that may carry the finction of the present invention.

FIG. 4A Is a side view of an oil recycling reservoir endowed with the features of a threaded device to facilitate transportation of used oil filters.

FIG. 5 Is a side view of the preferred embodiment having a one-way locking barbed surface.

FIG. 6 Is a top view of the filter side surface of the preferred embodiment showing radial locking indentations

FIG. 7 Is a side view or an embodiment having a threadable surface and breakaway torquing tab.

FIG. 8 Is a top view of the filter side surface of FIG. 7 embodiment.

### REFERENCE NUMERALS IN DRAWINGS

10. Locking barbs
12. Oil filter center threaded orifice
14. Spin-on oil filter
16. Barb surface
18. Barb locking surface
20. Internal filter plate surface
22. Device sealing surface
24. Device external surface
26. Filter circular gasket
28. Filter media
30. Press area
32. Spin on oil filter base plate
34. Spin-on oil filter recovery device
36. Circumference of contact
38. Developed area of contact
40. Time-release capsule
42. Filter bottom edge
44. Recycling reservoir
46. Reservoir cap
48. Large cap
50. Radial locking indentations
54. One-way circular barb
56. Printable external surface
57. Threadable cone
58. Self-threadable surface
59. Formed thread
60. Break away torque tab
64. Barbed cone plug

### MODE OF OPERATION

The present invention method and apparatus is based on a simple tool that promotes the handling, recovery, and recycling of used oil filters. The device is intended to be applied to the filter shortly after it is removed, or preferably after the filter has been partially and substantially drained after its removal from the engine. The present invention takes advantage of the spin on oil filter design features: a cylinder with an open end, a normally provided circular gasket, an anti drain-back membrane, and a threaded center channel.

The present invention is strongly secured by the user to the filter by the following: 1) The user pushes, or turns the device, which is equipped, on the opposite surface, with barbs or other locking means into the normally provided threaded center channel of the filter; 2) as the barbs, or other locking means, of the device travel through the threaded center channel, the barbs spring in a concentric manner toward the center of the device, or towards each other. This action allows the capturing of the barbs, or other locking means, inside the threaded section by means of a one way direction of retention, once the barbs spring back, inside the filter, to their original positions or against the threaded surface, therefore locking and capturing the present invention in a one-way hold, and 3) as the barbs are inserted into the filter, or other locking means, and subsequently captured, the sealing surface of the device, facing the oil filter, spring loads the sealing surface against the normally provided circular seal of the oil filter. Thus by the action of these three events, the device converts the filter into a sealed cylinder, effectively sealing the filter from leakage, rendering the filter easy to handle for proper disposal. Continued leaking of the internally trapped oil in oil filters is one, if not the main reason, why it is much easier to forget about the oil filter in favor of the trashcan and for the reason of being extremely messy. With this device, that problem is solved as soon as, or very shortly after, the filter is removed from the engine. Therefore, the utility of the present invention is of great benefit for the recovery and recycling of used filters.

To further mitigate the environmental impact of illegal filter dumping, a time-release capsule containing oil-eating bacteria, fungi, or other biological agent, can be provided as a further insurance against environmental damage. The inclusion of bacteria will be useful in those cases where filters are inevitably dumped by irresponsible DIYs. In time, the bacteria are released from its time-release capsule, and will render the oil in the filter, inert to the environment as the bacteria consume it. In another embodiment, the device may be equipped with absorbing gel to further capture the internal oil of the filter, attachment means, such as a hook or other attachment means may be included to make it even easier in situations where curbside pickup is available.

### DETAILED DESCRIPTION OF THE DRAWINGS

Referring to FIG. 1, a spin-on oil filter recovery device 34 is equipped with at least a pair of barbs 10, or if a plurality of the barbs 10 is chosen they substantially would be disposed in a circular pattern, and will eventually secured the spin-on oil filter recovery device 34. Still referring to FIG. 1, the barbs 10 are designed to have a sloped barb surface 16, in order to accommodate and be inserted into a normally provided oil filter center threaded orifice 12 of a common spin-on oil filter 14. Referring still to FIG. 1, the barbs 10 are substantially perpendicular to a device-sealing surface 22. The barbs 10 in their unbiased position are capable to be spring loaded toward each other by design, when barb surfaces 16 meet with the normally provided threaded orifice 12 of filter 14, barbs 10 substantially spring towards each other in a concentric manner to accommodate the diameter of the orifice 12. Surfaces 16 facilitate this process, as they are sloped and are responsible to spring barbs 10 towards each other as barbs 10 travel through orifice 12. Still referring to FIG. 1, a plurality of barb locking surface 18, will travel through orifice 12 through a distance TT′, allowing at the end of this travel for barbs 10 to return to their unbiased at rest position inside filter 14, thereby having the locking surfaces 18 of barbs 10 to meet against an internal filter plate surface 20, so that the device of the present invention 34 is securely trapped in a one-way lock and strongly affixed to filter 14.

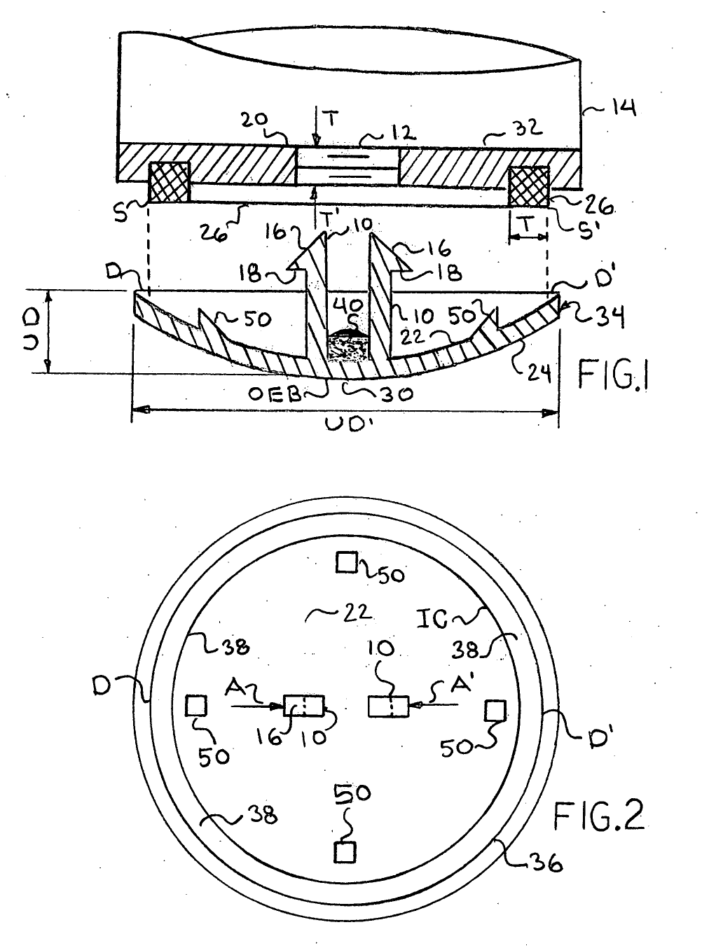

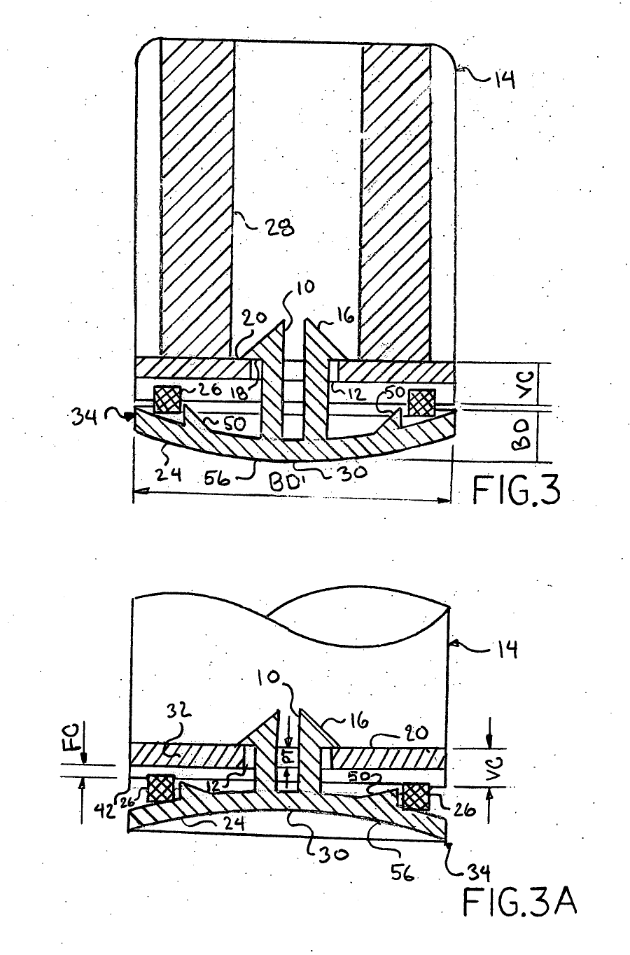

Referring now to FIG. 3, it will be very obvious to those skilled in the mechanical arts, that device 34 is virtually locked to filter 14, and effectively converts filter 14 into a sealed chamber with no means of easily removing device 34, until the point of recycling, which is in the end the objective of the present invention. Since the EPA, in a recent study in the State of Minnesota, has declared that the number one reason for not recycling the oil filters is their messy status once the filter is removed from the engine and during transportation, the device 34 of the present invention eliminates this condition by effectively sealing in a most effective manner the filter, effectively making it almost impossible for the residual oil in a normally provided filter media 28, to escape to the environment during transportation. Still referring to FIG. 3, device 34 is equipped with a press area 30, where the user presses against so that the device 34 is biased against filter 14, and barbs 10 move into filter orifice 12, and finally rest barb surfaces 18 against internal filter surface 20. Referring to FIGS. 1, 2, 3, 3A, 5, 6, 7, and 8, a plurality of locking indentations 50 circumferentially disposed is provided to further stabilize device 34. Referring now to FIG. 3, once the device 34 has locked in place, the biased dimensions of device 34 are different to their unbiased dimensions; such is the case with a biased dimension BD in FIG. 3, which is smaller than an unbiased dimension UD shown in FIG. 1. Again referring to FIG. 1, the unbiased dimension UD will become smaller when device 34 is applied to filter 14. This will cause the device-sealing surface 22 to meet against a normally provided filter circular gasket 26, and it will meet around a circumference in surface 22, defined by the contact of a continuum of points defined by two point sets SD and S'D' which belong to a circumference of contact 36 as shown in FIG. 2, having points D and D'. Still referring to FIG. 2, the circumference of contact 36, effectively will become a developed area of contact 38, with a thickness “t”, because seal 26 is substantially elastic and surface 22 can be made substantially conformable or coated with a conformable type of surface treatment, and upon meeting surface 22 of device 34, it will deform and develop into the suggested area of contact 38, bounded by an internal seal circumference IC and circumference 36, thereby providing the generous sealing area 38, aided by the concave shape of surface 22. Referring still to FIG. 2, sealing area 38 will be, in the upper limit, the thickness T of circular gasket 26 as shown in FIG. 1. Still referring to FIG. 1, notice that an unbiased device diameter UD' is slightly smaller than a biased device diameter BD' in FIG. 3 for the same device of course. Due to device 34 concave shape and choice of materials, upon the user pressing against area 30, the device 34 will spring by changing its dimension UD and UD', therefore storing potential energy for the device to keep surface 22 against seal 26. Now referring to FIG. 3A, it is apparent to those skilled in the art, that the foregoing explanation of how device 34 seals against gasket 26 also applies when device 34 surface 22 transitions from concave to convex due to normally provided mechanical clearance variances among filter manufacturers. Still referring to FIG. 3A, filters are generally designed within certain parameters and clearances, one parameter is a dimension FC, a clearance between an spin on oil filter base plate 32 and a normally provided filter bottom edge 42, another parameter is a total distance VC, which can be defined as the distance FC plus a plate thickness PT, which happens to be the distance that barbs 10 must travel before locking into the filter.

Referring to FIG. 3, those skilled in the art will observe that device 34 initial shape, when surface 22 is concave, has a great advantage in that it can accommodate many variants of dimensions PT plus FC, given that the likely material is flexible. Therefore, device 34 surface 22 can transition, depending on the amount of travel, from concave, to flat and finally to convex, in a way accommodating for all likely variances of VC as shown in FIG. 3 and FIG. 3A.

Now referring to FIG. 1, the device 34 lends itself to yet another innovative function in the control of oil dumping, a time-release capsule 40 may be included to prevent the oil from leaking if dumped in the trashcan and ends up in a landfill. Still referring to FIG. 1, the time-release capsule 40 is filled with a dormant colony of oil-eating bacteria OEB, fungi, or other mix of biological agents, such that if the used filter 14 is tossed in the trash, eventually with the passing of a suitable amount of time, the biological agents are released to feast on the remaining oil trapped inside the filter 14, rendering that oil inert after a suitable amount of time.

### PREFERRED EMBODIMENT AND OTHER EMBODIMENTS

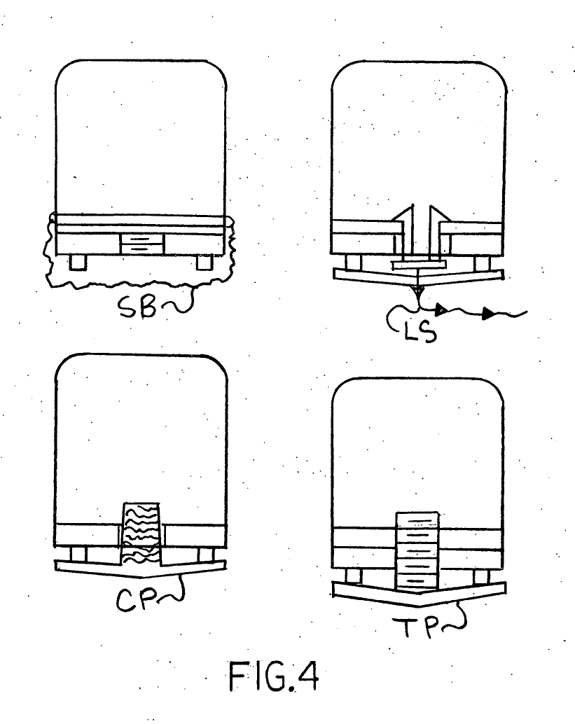

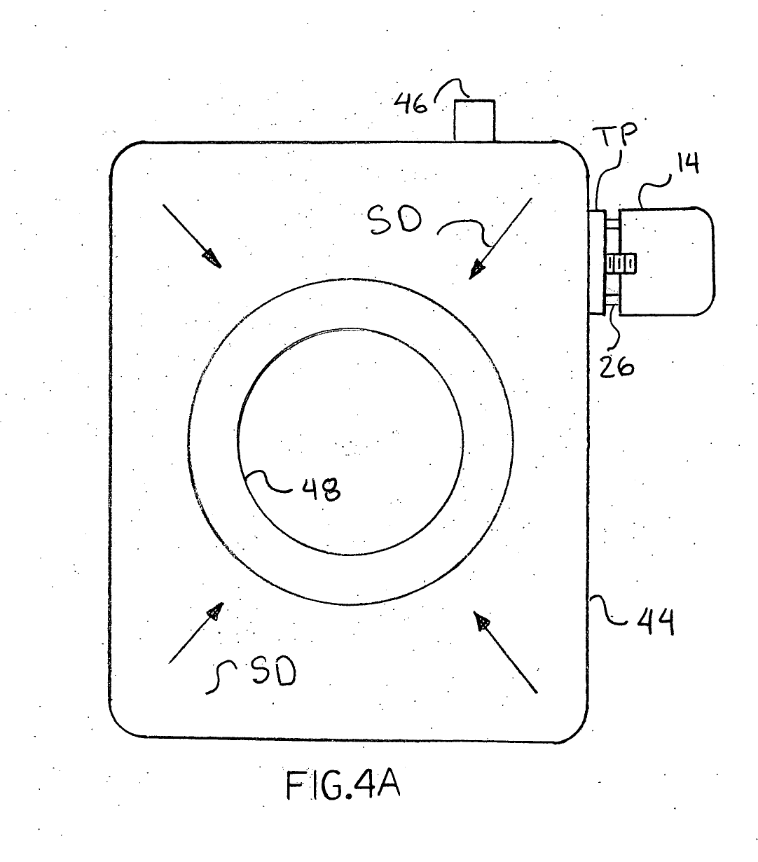

It is obvious to those skilled in the mechanical arts, that the device is simply elegant and that the utility it lends does not reside only on its simplicity of concept and construction, but in the ability to match its shape to low cost, convenience, societal need, ease of use, environmental usefulness, cost of manufacture, simplicity of concept in training, among others. It is now clear that many embodiments can now be suggested, including a sealing bag SB as shown in FIG. 4. Still referring to FIG. 4, a device LS, that uses a one-way locking string similar to a widely known “tie-wrap string” used to effectively secure device LS against the filter seal. In fact, this device is most effective in terms of material to be used. Rather than having the device yield under pressure, using a rigid plastic, in cooperation with a one way locking string with similar barbs accomplishes substantially the same task as the preferred embodiment. Yet another embodiment is a device CP equipped with a conical plug that effectively locks to the filter 14 through the orifice 12. Still referring to FIG. 4, yet another embodiment is a device TP with a threaded plug is shown. In fact, the utility of embodiment TP, takes relevance when the device shape is incorporated into many commercially available recycling reservoirs, such as a recycling reservoir 44 shown in FIG. 4A. It would be now apparent to those skilled in the art, that incorporating the device TP into the molded recycling reservoir would endow a recycling container with means of handling used oil filters simultaneously, therefore greatly enhancing the utility of a simple recycling reservoir. This is shown in FIG. 4A, where the recycling reservoir 44 is shown incorporating the features of device TP. The reservoir 44 is also equipped with a reservoir cap 46 to pour the oil out, a large cap 48 to facilitate the capture of oil coming from the normally provided sump plug in engines, and sloping areas SD to facilitate the oil collection.

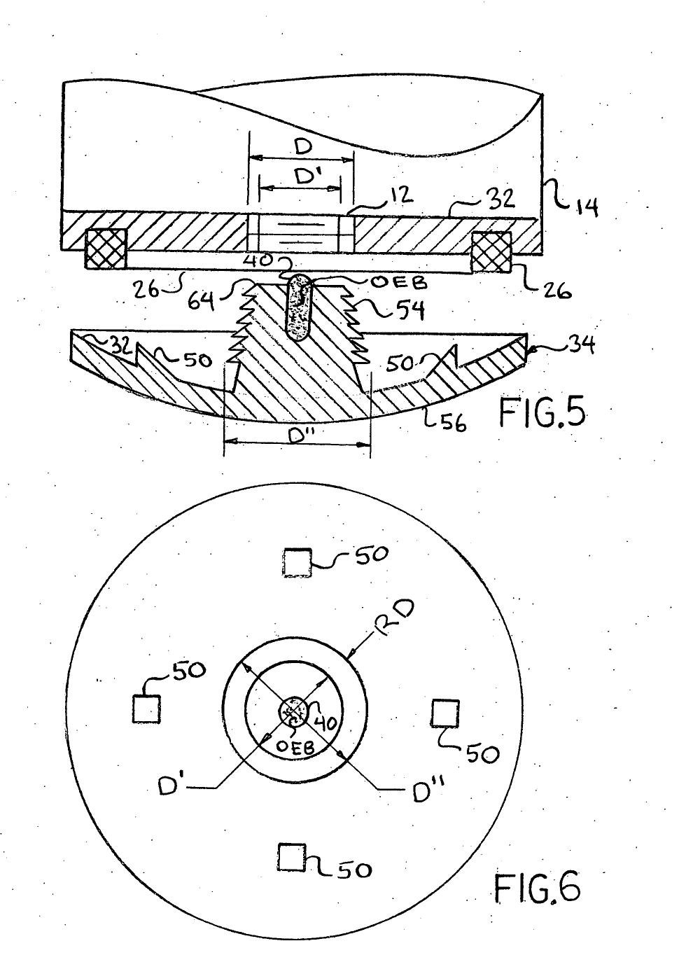

Now that the mechanical operation of device 34 has been extensively discussed, and referring to FIG. 5, it shows the preferred embodiment of the present invention. Without a discussion of the extensively disclosed manner of sealing the regular oil filter 14, this embodiment uses a barbed cone plug 64 that engages the normally provided center threaded orifice 12 in a one-way locked position once the device 34 is biased against filter 14, and a sealed condition is established between the device sealing surface 22 and the normally provided filter circular gasket 26. Although the barbed cone plug is self-centering once biased against filter 14, the locking indentations 50 are also provided for further alignment and stability. Still referring to FIG. 5, the time-release capsule 40 containing the oil-eating bacteria OEB is also provided. Note that the plug 64 is designed so that a range of diameters RD, as shown in FIG. 6, is possible in order to accommodate the range of diameters of threaded orifice 12 in FIG. 5. Referring to FIGS. 1, 3, 3A, 5 and 7, the device 34 of the present invention also is equipped with a external printable surface 56, which serves to communicate relevant information on the device and its environmental mission, or even sponsorship.

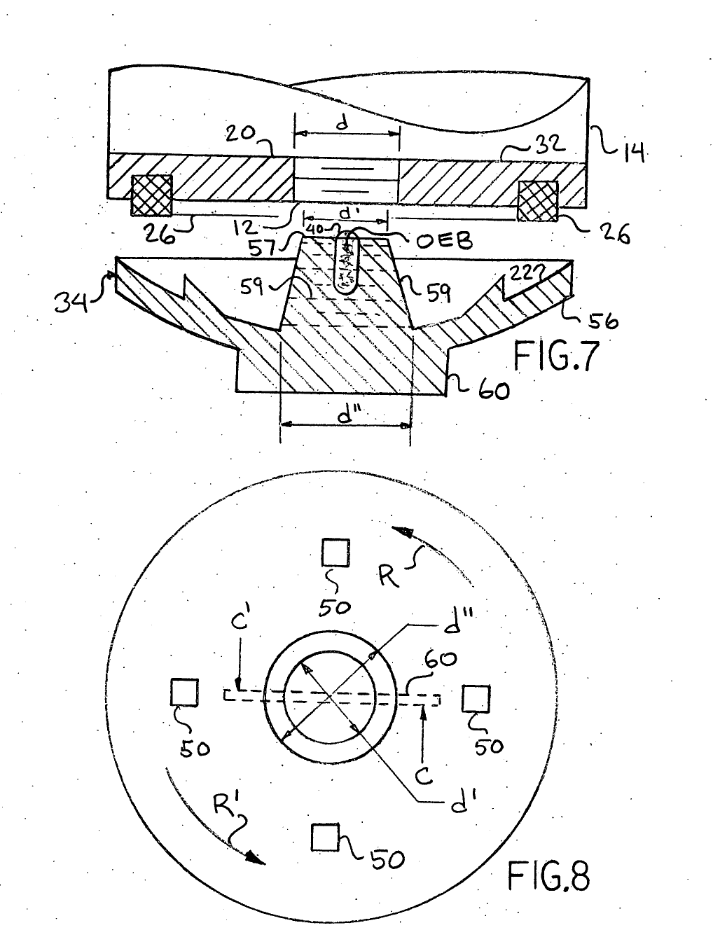

Yet another embodiment of the present invention is shown in FIG. 7, where the mechanical sealing abilities of device 34 are the same as abundantly discussed. Here device 34 only changes by having a conical plug 57, having a range of diameters from d to d', as shown in FIG. 8, in order to accommodate a diameter d of orifice 12, as shown in FIG. 7. The conical plug 57 has the ability to have a self-threadable surface 58, which upon insertion into the normally provided filter threaded orifice 12 of filter 14, allows the user to impart a torque couple CC', by applying couple CC' to a break away tab 60 shown in FIG. 7, and as shown in FIG. 8, such couple CC' imparts a rotation indicated by a motion RR' shown in FIG. 8. This action allows the threaded orifice 12 to act as a thread making die and generate a formed thread 59 on thread surface 58, thereby sealing orifice 12, while pressing device 34 against gasket 26 as device 34 rotates clockwise, for a right hand thread. Once device 34 reaches a travel limit into orifice 12, the user proceeds to break-away tab 60, therefore making the removal of device 34 very difficult, since no means to apply an opposite torque couple to unscrew device 34 is available. Once the tab 60 is removed, the device effectively seals filter 14, and the time-release capsule 40 is also provided with the oil-eating bacteria OEB, or other biological agent, to reduce or eliminate the potential environmental damage of the residual oil of used filter 14 if it becomes illegally dumped.

Other improvements may include treatment for surface 22 such as absorbing gel, paper to further absorb oil, among others, for the purpose of protecting the environment should the filter end up in a landfill.

It will be understood that each of the elements described above, or two or more together may also find a useful application in other types of methods differing from the type described above.

It thus will be seen that there are provided systems which achieve the various objects of the invention and which are well adapted to meet the conditions of practical use and public welfare.

While certain novel features of this invention have been shown and described and will be pointed out in future claims, it is not intended to be limited to the details above, since it will be understood that various omissions, modifications, substitutions and changes in the forms and details of the device illustrated and in its operation can be made by those skilled in the art without departing in any way from the spirit and scope of the present invention.

I claim:

1. A method to promote cylindrically shaped used spin-on oil filter recycling, said method comprising the steps of:
a. providing a substantially circular sheet, said sheet having an external surface and an internal surface;
b. providing in said internal surface a centrally located appendage affixed to said internal surface, said appendage equipped with locking means;
c. providing a used spin-on oil filter, said used spin-on oil filter containing environmentally damaging contents, said used spin-on oil filter normally equipped with a normally provided open circular end, said circular end normally provided with a centrally located threaded opening and a normally provided circular gasket;
d. inserting said centrally located appendage in b into said centrally located threaded opening in c, by urging said sheet in a against said open circular end in c; whereby said environmentally damaging contents in c are prevented from leaking to the environment by a sealingly contact made by said internal surface in step a with said circular gasket in step c, after performing step d.

2. The method of claim 1 wherein said circular sheet substantially matches the circular dimension of said cylindrically shaped used spin-on oil filter.

3. The method of claim 1 wherein said centrally located appendage in step b is substantially conical in shape and having one-way locking means.

4. The method of claim 1 wherein said centrally located appendage in step b is a substantially cylindrical threaded stud.

5. The method of claim 1 wherein said centrally located appendage in step b is a plurality of one-way locking barbs acting as said locking means.

6. The method of claim one wherein said internal surface is provided with an oil-eating bacteria cocktail.

7. The method of claim 1 wherein said external surface is printable.

8. An apparatus for promoting used oil filter recycling and biological control of their residual oil, said apparatus comprising:
a circular sheet having an external surface and an internal surface;
said internal surface equipped with at least one centrally located appendage;
said internal surface equipped with an oil-eating bacteria cocktail; and
said centrally located appendage provided with one-way locking means.

9. The apparatus of claim 8, wherein said appendage is provided with a self-threadable surface and further comprising a removable tab centrally located in said external surface.

10. The apparatus of claim 8, wherein said oil-eating bacteria cocktail is contained in a time release reservoir.

11. The apparatus of claim 8, further comprising oil absorbing means.

12. The apparatus of claim 8, further comprising a biodegradable material for its Structure.

13. The apparatus of claim 8, further comprising a plurality of locking indentations to align said apparatus concentrically with said spin-on oil filter.
